(19) United States
(12) Patent Application Publication
(10) Pub. No.: US 2021/0342833 A1
(43) Pub. Date: Nov. 4, 2021

(54) ITEM-GENERATING METHOD BASED ON BLOCKCHAIN

(71) Applicant: XSODION CO., LTD., Seoul (KR)

(72) Inventor: Ho Yeol Shin, Seoul (KR)

(21) Appl. No.: 17/268,930

(22) PCT Filed: Jul. 16, 2019
(86) PCT No.: PCT/KR2019/008796

§ 371 Date: Feb. 16, 2021

(30) Foreign Application Priority Data
Aug. 23, 2018 (KR) 10-2018-0098786

(51) Int. Cl. G06Q 20/40; G06F 16/23

(52) U.S. Cl. CPC G06Q 20/401; G06Q 2220/00; G06F 16/2379

(57) ABSTRACT

An item-generating method based on a blockchain is proposed. The item-generating method based on the blockchain includes: recording, by a blockchain server, transaction information in a block when a transaction request is received from a user device; transmitting, by the blockchain server, the transaction information to a service providing server, when a recipient of the transaction request is the blockchain server, and recording, by the service providing server, the transaction information in a blockchain database; inquiring, by the service providing server, about the transaction information in the blockchain database according to a transaction check request transmitted from the user device, generating item information corresponding to the inquired transaction information, and transmitting the item information to the blockchain server; and additionally recording, by the blockchain server, the item information in the block.

### TECHNICAL FIELD

The present invention relates to an item-generating method based on a blockchain and, more particularly, to a method of generating an item in addition to a transaction, and blocking the item.

### BACKGROUND ART

Recently, the fourth industrial revolution characterized by the fusion of information communication technologies has become an issue. In existing industries, automation meant that a machine is passively operated according to pre-recoded programs. However, in the fourth industrial revolution, automation means that a machine is operated by actively understanding the situation. The fourth industrial revolution will be led by artificial intelligence, robotics and life science, etc. In particular, block chain to which attention has been drawn as a core element technology of the fourth industrial revolution is a technology to distribute and manage accounts recording transaction information in P2P network.

In the meantime, items or free gifts have been provided so as to promote various services such as electronic commerce or sale of goods. However, as such a process to select an item and designate a recipient thereof on line is usually not open to the general public, reliability has been in fact not given to item-providing systems.

### DISCLOSURE

### Technical Problem

Accordingly, the present invention is intended to provide an item-providing method based on a blockchain, so that reliability thereof can be ensured.

### Technical Solution

An item-generating method based on a blockchain according to an embodiment of the present invention includes: recording, by a blockchain server, transaction information in a block when a transaction request is received from a user device; transmitting, by the blockchain server, the transaction information to a service providing server, when a recipient of the transaction request is the blockchain server, and recording, by the service providing server, the transaction information in a blockchain database; inquiring, by the service providing server, about the transaction information in the blockchain database according to a transaction check request transmitted from the user device, generating item information corresponding to the inquired transaction information, and transmitting the item information to the blockchain server; and additionally recording, by the blockchain server, the item information in the block.

### Advantageous Effects

According to an embodiment of the present invention, reliability may be secured because items are provided on a blockchain basis.

According to an embodiment of the present invention, completion or not of the transaction may be confirmed to a user even before proof of work for a block in which transaction information is recorded on the network is performed.

According to an embodiment of the present invention, an item may be immediately generated with respect to the confirmed transaction, and therefore, the item may be promptly generated even before proof of work for a block in which transaction information is recorded on the network is performed.

### DESCRIPTION OF DRAWINGS

FIG. 1 is a view illustrating an item-generating system based on a blockchain according to an embodiment of the present invention.

FIG. 2 is a flowchart schematically illustrating an item-generating method based on a blockchain according to an embodiment of the present invention.

FIG. 3 is a flowchart specifically illustrating the step of registering user information of FIG. 2.

FIG. 4 is a flowchart specifically illustrating the step of processing a transaction of FIG. 2.

FIG. 5 is a flowchart specifically illustrating the step of generating an item of FIG. 2.

FIG. 6 is a view of illustrating an example of an item-generating table according to an embodiment of the present invention.

FIG. 7 is a flowchart specifically illustrating the step of providing an item list of FIG. 2.

FIG. 8 is a view illustrating an example of an item list according to an embodiment of the present invention.

### MODE FOR INVENTION

Hereinbelow, an embodiment of the present invention will be described in detail with reference to the accompanying drawings.

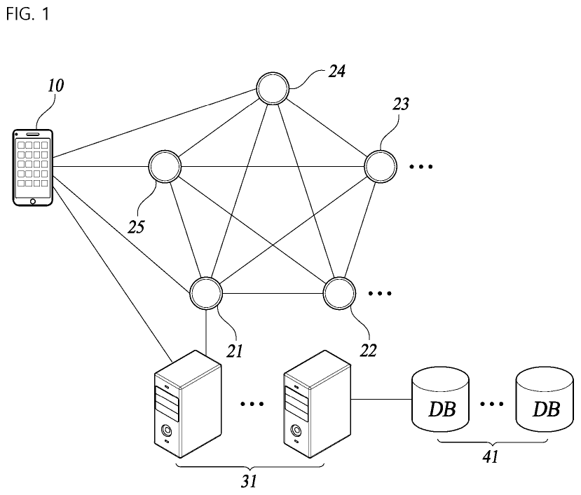

FIG. 1 a view illustrating an item-generating system based on a blockchain according to an embodiment of the present invention. Referring to FIG. 1, the item-generating system based on a blockchain may include a user device 10, a blockchain server 21 to 25, a service providing server 31, and a blockchain database 41. The user device 10 or the blockchain server 21 may be connected to each of a plurality of service providing severs 31 or to any one of the plurality of service providing servers 31. The plurality of service providing servers 31 may be interconnected, and a plurality of blockchain databases 41 may be interconnected.

FIG. 1 illustrates that the service providing server 31 and the blockchain database 41 are connected only to the blockchain server 21, for the convenience of illustration. However, the service providing server 31 and the blockchain database 41 may also be connected to another blockchain server 22 to 25. Also, it is illustrated that the service providing server 31 and the blockchain database 41 are multiple, but one service providing server 31 and/or one blockchain database 41 may only be included.

As a device to which a user makes an access, so as to purchase an article or a service, the user device 10 may be a mobile device in which an application implementing an item-generating method based on a blockchain according to an embodiment of the present invention is installed and executed. The user may make user registration through the user device 10 and make a transaction such as purchase of an article or a service. Also, the user may check an item generated during the transaction through the user device 10.

The blockchain server 21 is connected to the user device 10 or another blockchain server 22 to 25 in a P2P manner. Also, the blockchain server 21 is connected to the service providing server 31. The blockchain server 21 records transaction information transmitted from the user device 10 in a block and transmits the transaction information to another block chain server 22 to 25. In addition, when the transmitted transaction information is directed to the concerned blockchain server 21, the blockchain server 21 transmits the transaction information to the service providing server 31, thereby allowing the transaction to be executed. In addition, the blockchain server 21 additionally records item information generated by the service providing server 31 in the block. That is, as the transaction information and the item information are recorded on the blockchain, any modification in the transaction information and the item information is prevented, so that reliability thereof can be ensured.

The service providing server 31 is connected to the blockchain server 21 and stores transaction information in the blockchain database 41 according to a transaction request transmitted from the blockchain server 21. In addition, after storing the transaction information, the service providing server 31 generates an item corresponding to the transaction. FIG. 1 illustrates only the service providing server 31 connected to the blockchain server 21. However, there may be another service providing server connected to the other blockchain server 22 to 25. The service providing servers connected to the blockchain servers 21 to 25 may provide services different from each other. The different services may include a case where the targets of the provided services such as game, movie, record, etc. are different and also a case where the entities to provide the services are different.

The blockchain database 41 is connected to the service providing server 31. FIG. 1 illustrates only the blockchain database 41 connected to the service providing server 31. However, there may be another blockchain databases connected to the service providing servers (not shown) connected to the respective blockchain servers 22 to 25. The blockchain database 41 registers the user information provided from the service providing server 31. In addition, the blockchain database 41 stores transaction information and item information provided from the service providing server 31. The blockchain database 41 may inquire about user information, transaction information, or item information stored therein and may provide the same to the service providing server 31.

Next, an item-generating method based on a blockchain performed in the item-generating system based on a blockchain as illustrated in FIG. 1 will be described below.

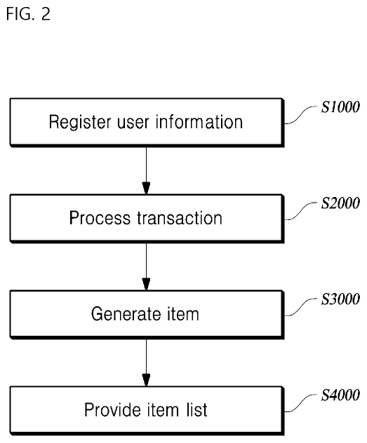

FIG. 2 is a flowchart schematically illustrating an item-generating method based on a blockchain according to an embodiment of the present invention.

Referring to FIG. 2, the item-generating method based on a blockchain may include the steps of registering user information (S1000), processing a transaction (S2000), generating an item (S3000), and providing an item list (S4000).

Registration of user information (S1000) is to specify a user prior to performing a transaction. The user information is registered in a blockchain database 41 and login is performed.

In processing of transaction (S2000), the blockchain server 21 records transaction information in a block according to a transaction request from the user device 10 and the service providing server 31 records the transaction information in the blockchain database 41.

In generation of an item (S3000), the service providing server 31 generates an item corresponding to the transaction information after the transaction information is recorded in the blockchain database 41.

In provision of an item list (S4000), a list of the generated items is provided to the user device 10.

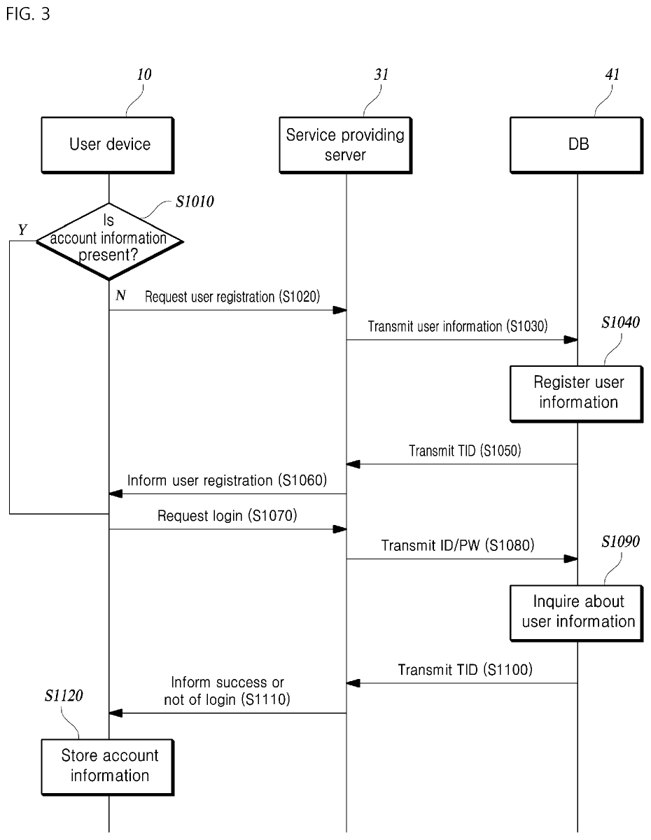

FIG. 3 is a flowchart specifically illustrating the step S1000 of registering user information of FIG. 2. Registration of the user information (S1000) may include the steps of registering a user (S1010 to S1060) and the steps of logging in the user (S1070 to S1120).

First, the user device 10 determines whether account information of the user is present (S1010). When it is determined that the account information is not present (S1010, N), the user device 10 requests user registration to the service providing server 31 (S1020). At this time, in order to request the user registration, the user device 10 may transmit to the service providing server 31 a device ID of the user device 10 and a password automatically generated, and the ID and the password established by the user, as user information. The device ID may be, for example, a 20-character string, and the automatically generated password may be, for example, a 10-character string.

The service providing server 31 transmits the user information received from the user device 10 to the blockchain database 41 (S1030). The blockchain database 41 generates a TID and stores the generated TID in response to the user information (S1040). The TID is a value to identify a user in the blockchain database 41 and, for example, may be an integer of 8 bytes.

The blockchain database 41 transmits the generated TID to the service providing server 31 (S1050). The service providing server 31 informs the user device 10 that user registration has been completed (S1060). At this time, the service providing server 31 may transmit the TID received from the blockchain database 41 to the user device 10.

After registration of a user account has been completed as described above, when login of the user is requested with the ID and the password of the user from the user device (S1070), the service providing server 31 transmits the ID and the password to the blockchain database 41 (S1080). The blockchain database 41 inquires about whether the ID and the password are registered therein (S1090). When the ID and the password are registered, the blockchain database 41 transmits to the service providing server 31 a TID corresponding thereto (S1100). In response to the received TID, the service providing server informs the user device 10 of success or not of the login (S1110).

At this time, the service providing server 31 may transmit information about success or not of the login (having a value of true or false), the TID received from the blockchain database 41, and a service code of the user device 10. As described above, a plurality of service providing servers including the service providing server 31 provide a plurality of services different from each other. The service code is a value to identify those services and, for example, may be an integer of 4 bytes.

Upon receiving information about success or not of the login from the user device 10, the user device 10 may store, for a login request (S1070), the ID and password input therein (S1120). According to this, the user has no need to input the ID and the password in the user device 10 in performing the future login procedure.

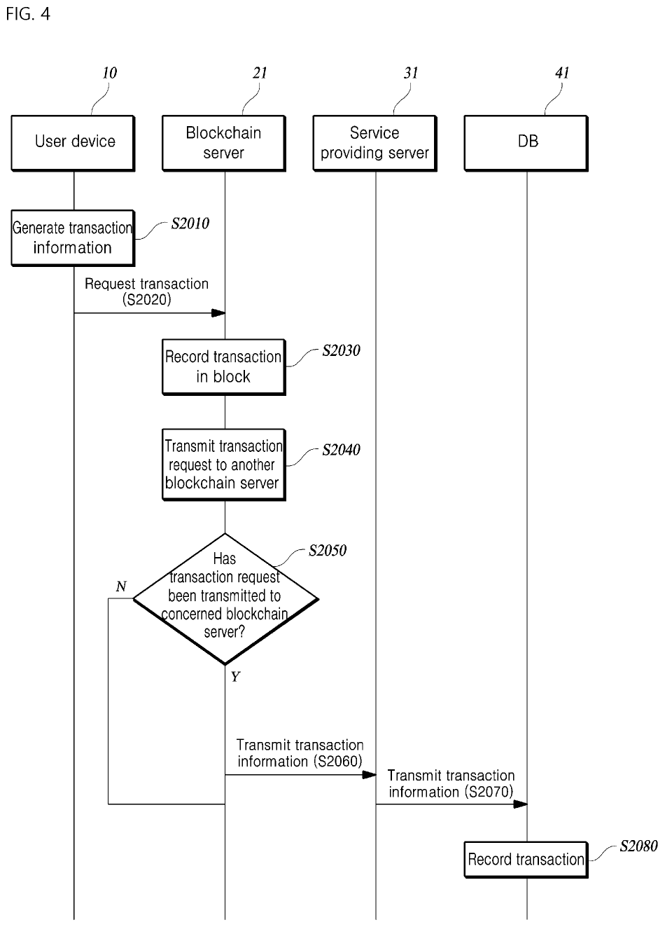

FIG. 4 is a flowchart specifically illustrating the step S2000 of processing a transaction of FIG. 2.

Referring to FIG. 4, the user device 10 generates transaction information (S2010). The transaction information may include purchaser (user) information (for example, TID), merchandiser information (address of a blockchain server), and transaction amount. For the transaction amount, conventional virtual currencies such as Bitcoin or Ethereum, etc. may be used, or a new kind of virtual currency for implementing an embodiment of the present invention may be used. In addition, the transaction amount may be paid by means of a credit card or a debit card. Also, the user device 10 may additionally generate a public key. The public key is a value to encrypt the transaction information. The public key is generated on the basis of the address of the user device 10, and for example, may be a 20 character string.

The user device 10 requests a transaction to a blockchain server 21 to 25 (S2020). FIG. 4 illustrates that the user device 10 requests the transaction only to the blockchain server 21. However, the transaction may also be requested to another blockchain server 22 to 25 as well as the blockchain server 21. When the transaction is requested, the user device 10 may transmit a public key and a service code together with the transaction information.

The blockchain server 21 records the received transaction information in a block (S2030), and then sends a transaction request to another blockchain server 22 to 25 (S2040).

Next, the blockchain server 21 determines whether the transaction request is directed to the blockchain server 21 (S2050). That is, the blockchain server 21 determines whether the merchandiser's address included in the transaction information corresponds to the address of the concerned blockchain server 21. When the transaction request is directed to the blockchain server 21 (S2050, Y), the transaction information is transmitted to the service providing server 31 (S2060). At this time, the transaction information transmitted by the blockchain server 21 to the service providing server 31 may not be necessarily in an identical form to the transaction information received from the user device 10. After having received from the user device 10 the TID, the address of the blockchain server and the transaction amount as transaction information, the blockchain server 21 may calculate transaction hash on the basis of the TID, the address of the blockchain server and the transaction amount, and transmit to the service providing server 31 the transaction hash and the TID as transaction information. The blockchain server 21 may transmit to the service providing server 31 a public key and a service code together with the transaction information.

The service providing server 31 transmits the received transaction information to the blockchain database 41 (S2070). At this time, the service providing server 31 may transmit to the blockchain database 41 a public key and a service code together with the transaction information. The blockchain database 41 records the transaction information received from the service providing server 31 in the blockchain database S2080. At this time, the blockchain database 41 may record transaction information in response to the TID received from the service providing server 31, and a public key may be recorded together.

When the transaction request is not directed to the concerned server 21 (S2050, N), the blockchain server 21 transmits the transaction request to another blockchain server 22 to 25. The blockchain server 22 to 25 having received the transaction request performs the process from S2030 to S2080 although it is not illustrated in FIG. 4.

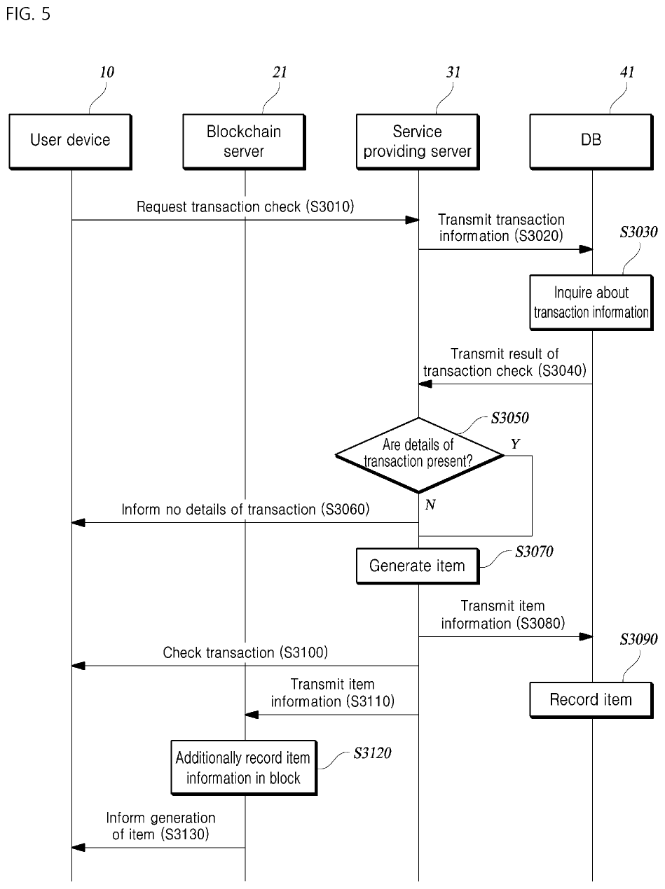

FIG. 5 is a flowchart specifically illustrating the step S3000 of generating an item of FIG. 2.

Referring to FIG. 5, the user device 10 requests that the service providing server 31 checks a transaction (S3010). When the transaction check is requested to the service providing server 31, the user device 10 may transmit transaction hash and a TID as transaction information. The user device 10 may transmit a public key together with the transaction information.

The service providing server 31 transmits the received transaction information to the blockchain database 41 (S3020) and inquires about the transaction information in the blockchain database 41 (S3030). The service providing server 31 may transmit the public key received together with the transaction information to the blockchain database 41. In this case, the blockchain database 41 inquires about whether the transaction information and the public key have been registered.

Next, the blockchain database 41 transmits the result of inquiry (S3040). According to the result of transaction inquiry, the service providing server 31 determines whether the details of a transaction are present (S3050). When there are no details of the transaction (S3050, N), the service providing server 31 informs the user device that there are no details of the transaction (S3060). When there are any details of the transaction (S3050, Y), the service providing server 31 generates an item (S3070). A specific method of generating an item will be described below.

After generating the item, the service providing server 31 transmits information about the generated item (item information) to the blockchain database 41 (S3080). Information about the item may be, for example, an item ID. The service providing server 31 may also transmit transaction information, for example, transaction hash and TID, together with the item information, to the blockchain database 41. The blockchain database 41 records the received item information (S3090). At this time, the blockchain database 41 may record item information in response to the received transaction information, that is, transaction hash and TID. A public key may also be included in the information transmitted by the service providing server 31 to the blockchain database 41. In this case, the blockchain database 41 may record the item information in response to the transaction information and the public key.

In the meantime, when there are any details of the transaction (S3050, Y), the service providing server 31 informs the user device 10 that the transaction has been achieved (S3100). FIG. 5 illustrates that the transaction check (S3100) is performed after transmission of the item information (S3080). However, the transaction may be checked any time after it is determined that there are any details of transaction (S3050).

The service providing server 31 transmits the item information to the blockchain server 21 (S3110). At this time, the service providing server 31 may transmit together an open address of the purchaser, an item amount and a TID as well as the item information, that is, an item ID. The blockchain server 21 additionally records the received item information in the block (S3120). In order to record the item information in the block, there must be an amount corresponding to an item. Accordingly, the service providing server 31 needs to establish the item amount. The item amount may be calculated, for example, in proportion to the transaction amount. That is, the item amount may be a value to make a predetermined portion of the transaction amount paid back to the user (purchaser).

In this regard, the item amount may be allowed to be paid back by a specific kind of virtual currency. For example, in case where the transaction amount is paid by a new kind of virtual currency for implementing an embodiment of the present invention, payback may be available by the virtual currency of the same kind as the paid virtual currency. Even in case where the transaction amount is paid by an existing virtual currency, or a credit card or a debit card, payback may be available by the new kind of virtual currency. However, this is by way of an example and the item amount may be paid back by the currency of the same kind as the transaction amount.

After the item information is recorded in the block, the blockchain server 21 informs the user device 10 that an item has been generated (S3130). At this time, the blockchain server 21 may transmit the item information (item ID) and the item amount to be paid. According to this, the user device 10 stores the item information and the item amount in a memory in which information associated with an item is stored and may indicate the same in a display.

According to an embodiment of the present invention, as the item information as well as the transaction information are recorded in a block, forgery or falsification of the item information is prevented, so that reliability can be ensured.

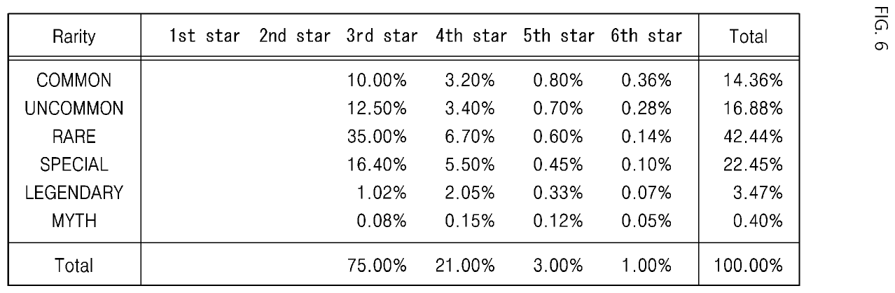

FIG. 6 is a view of illustrating an example of an item-generating table according to an embodiment of the present invention. The item-generating table of FIG. 6 may be used when an item is generated in the service providing server 31. However, FIG. 6 illustrates an example of an item-generating table, and the item generation probabilities may be established differently.

Referring to FIG. 6, the item-generating table may predetermine item generating probabilities according to six rarities of COMMON, UNCOMMON, RARE, SPECIAL, LEGENDARY, and MYTH, and 1st to 6th star grades. In other words, an item has a rarity and a grade, and has a generation probability established in the item-generation table of FIG. 6 according to the rarity and the grade. At this time, an item provided may not be necessarily of the same kind as a service subject to a transaction. For example, in case where a service that a purchaser (user) desires to transact is a game, a cosmetic product as well as items used in the game may be provided. The generation probability of each item may be determined depending upon the number of the respective items that can be provided. For example, where many items are available to be provided, the item generating probabilities may be established higher. Where small items are available to be provided, the item generating probabilities may be established lower. A grade of each item may be established by classifying the generating probabilities of items according to the predetermined standard(s).

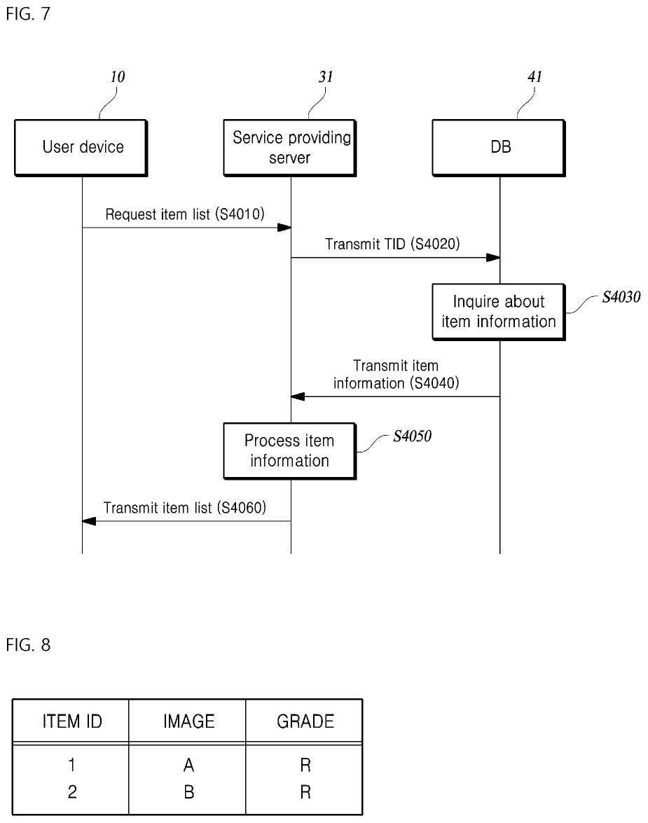

FIG. 7 is a flowchart specifically illustrating the step S4000 of providing an item list of FIG. 2.

Referring to FIG. 7, the user device 10 requests an item list to the service providing server 31 (S4010). At this time, the user device 10 may transmit a TID.

As an item list is requested from the user device 10, the service providing server 31 transmits the TID to the blockchain database 41 and requests an item list together (S4020).

As the item list is requested from the service providing server 31, a second blockchain database 41 inquires about whether any item information corresponding to the TID is present (S4030), and the second blockchain database 41 transmits the inquired item information to the service providing server 31 (S4040). At this time, the transaction hash may be provided together with the item information.

The service providing server 31 processes the item information received from the second blockchain database 41, thereby generating an item list (S4050). The service providing server 31 transmits the generated item list to the user device 10 (S4060).

FIG. 8 is a view illustrating an example of an item list according to an embodiment of the present invention.

Referring to FIG. 8, an item list may include item IDs, images and grades. By transmitting an item ID of an item corresponding to the TID of the user device 10, and an image and a grade thereof, the item list is provided in a manner whereby items possessed by the user can be recognized at a glance.

The present invention has been described in detail through a preferred embodiment, but the present invention is not limited thereto, and it is apparent that modifications and applications can be made in various manners by those skilled in the art within the scope not beyond the technical spirit of the present invention. Accordingly, the true protection scope of the present invention should be interpreted by the appended claims, and the entire technical spirit within the scope equal thereto should be interpreted to be covered by the scope of the present invention.

1. An item-generating method based on a blockchain, the method comprising:
recording, by a blockchain server, transaction information in a block when a transaction request is received from a user device;
transmitting, by the blockchain server, the transaction information to a service providing server, when a recipient of the transaction request is the blockchain server, and recording, by the service providing server, the transaction information in a blockchain database;
inquiring, by the service providing server, about the transaction information in the blockchain database according to a transaction check request transmitted from the user device, generating item information corresponding to the inquired transaction information, and transmitting the item information to the blockchain server; and
additionally recording, by the blockchain server, the item information in the block.

2. The method of claim 1, wherein the service providing server comprises a plurality of items and a table indicating a generation probability of each item, and generates an item based on the generation probability.

3. The method of claim 1, wherein in the transmitting the item information, the service providing server generates the item information in response to the transaction information.

4. The method of claim 3, wherein the item information comprises an item amount calculated on the basis of transaction amount, thereby allowing the item amount to be paid back.

5. The method of claim 1, further comprising:
transmitting, by the service providing server, transaction check information to the user device when the transaction information inquired in the blockchain database according to the transaction check request is checked.

6. The method of claim 5, wherein the inquiry about the transaction information in the blockchain database is performed before proof of work for the transaction information recorded in the block is performed.

7. The method of claim 5, wherein the transmitting the transaction check information can be executed before the proof of work for the transaction information recorded in the block is performed.

8. The method of claim 1, further comprising:
transmitting, by the blockchain server, the transaction request to another blockchain server when the recipient of the transaction request is not the blockchain server.

9. The method of claim 1, further comprising:
registering user information to establish a value for identifying a user,
wherein the transaction information comprises a value for identifying the user.

10. The method of claim 1, further comprising:
inquiring, by the service providing server, about item information corresponding to the user device in the blockchain database according to an item list request from the user device, generating an item list based on the inquired item information, and transmitting the item list to the user device.

11. A method of receiving a transaction request from a user device and operating a blockchain server connected to a service providing server corresponding thereto, the method comprising:
receiving a transaction request from the user device;
recording transaction information corresponding to the transaction request in a block, and transmitting the transaction request to at least one of other blockchain servers;
transmitting the transaction information to the service providing server when the recipient address included in the transaction information corresponds to the address of the blockchain server; and
recording item information in the block when the item information corresponding to the transaction information is received from the service providing server.

12. A method of operating a service providing server connected to a blockchain server corresponding thereto and a blockchain database corresponding thereto, the method comprising:
recording transaction information in the blockchain database when the transaction information recorded in a block is received from the blockchain server;
inquiring about the transaction information in the blockchain database when a check request of the transaction information is received from the user device; and
generating item information corresponding to the transaction information when the transaction information is checked in the blockchain database, and transmitting the generated item information to the blockchain server so as to allow the item information to be additionally recorded in the block.
